(19) United States
(12) Patent Application Publication
(10) Pub. No.: US 2015/0058202 A1
(43) Pub. Date: Feb. 26, 2015

(54) SYSTEM AND METHOD FOR TRACKING AND CONTROLLING OWNERSHIP OF DIGITAL WORKS AND REWARDING AUTHORS, ARTISTS AND/OR THEIR REPRESENTATIVES OVER TIME

(71) Applicant: David Dahaeck, Antwerpen (BE)

(72) Inventor: David Dahaeck, Antwerpen (BE)

(21) Appl. No.: 14/463,904

(22) Filed: Aug. 20, 2014

Related U.S. Application Data
(60) Provisional application No. 61/868,533, filed on Aug. 21, 2013.

(51) Int. Cl. G06F 21/10; G06Q 20/10; H04L 9/08

(52) U.S. Cl. CPC G06F 21/10; H04L 9/0861; G06Q 20/10; G06F 2221/07
USPC 705/39; 726/28

(57) ABSTRACT

The present invention generally relates to systems and methods for tracking digital works and compensating authors thereof. Specifically, this invention relates to systems and methods for tracking and controlling ownership of digital works (e.g., images, video, sound, code, written works) and the compensation of the authors/artists of such digital works throughout the lifespan of the digital work. Preferred embodiments of the present invention utilize security code keys to manage and track the digital works while a centralized or distributed computerized system manages compensation of the author/artist based on current value or transaction value of the related digital work.

### CROSS-REFERENCE TO RELATED APPLICATION

The present application claims priority from provisional application 61/868,533 filed on Aug. 21, 2013 and entitled System and Method for Tracking and Controlling Ownership of Digital Works and Rewarding Authors, Artists and/or their Representative(s) Over Time, the content of which is hereby incorporated by reference into this application.

### FIELD OF THE INVENTION

The present invention generally relates to systems and methods for tracking digital works and compensating authors thereof. Specifically, this invention relates to systems and methods for tracking and controlling ownership of digital works (e.g., images, video, sound, code, written works) and the compensation of the authors/artists and/or their representatives of such digital works throughout the lifespan of the digital work, both in the primary market as in the secondary market. Preferred embodiments of the present invention utilize security code keys to manage and track the digital works while a centralized or distributed computerized system manages compensation of the author/artist based on current value or transaction value of the related digital work.

### BACKGROUND OF THE INVENTION

Computer digitization makes copying and distributing electronic media such as images, video, sound, code, and written works trivially easy. Although this produces many benefits, it creates at least two problems for creators or artists. First, artists will have a very difficult time enforcing their moral rights, for example, when the artwork is being misused or misrepresented. Second, it is difficult for artists to participate in the increase in value of their work after the initial sale. These problems arise generally because digital artwork is so easy to copy and transfer without any interaction from the original artist. In order to address these issues a way for artists to securely control, track, and manage the sale a resale of their artwork is required.

In addition, even in countries where laws have been enacted to protect the moral rights of and ensure fair trade for artists, these provisions are often directed toward physical works and there is no method in place for providing the same protections and guarantees in the digital realm.

Therefore, there is a need in the art for a system and method which allows artists to manage digital artworks by controlling the sale, tracking the sequence of subsequent ownership, receive some portion of the increase in value at the time of resale, and managing moral rights of artwork in the digital realm.

### SUMMARY OF THE INVENTION

Accordingly, it is an object of the present invention to provide a system and method which allows artists to upload digital artworks, sell artworks, track subsequent ownership of artworks, manage moral rights, and participate, at least in part, in the increase in value of artwork when it is transferred between third parties.

A system for tracking and controlling ownership of digital information comprises: a processor, and memory with computer executable code configured to: receive a first user's identification information; receive a digital file from the first user; receive identification information for a first buyer; generate a first transfer key associated with both the digital file and the first buyer; and transfer ownership of the digital file from the first user to the first buyer, wherein the first transfer key is used to verify that the first buyer is authorized to receive ownership of the digital file.

The system is further configured to: receive identification information for a subsequent buyer; generate a subsequent transfer key associated with both the digital file and the subsequent buyer; and transfer ownership of the digital file to the subsequent buyer, wherein the subsequent transfer key is used to verify that the subsequent buyer is authorized to receive ownership of the digital file.

The system is further configured to generate a public key associated with the digital file, wherein the public key allows general access to information about the digital file.

The system is further configured to provide viewers of the digital file with the public key corresponding to the digital file.

The system wherein the public key is provided in a QR code superimposed on the digital file when the digital file is displayed.

The system wherein the public key is provided in a hyperlink superimposed on the digital file when the digital file is displayed.

The system is further configured to provide a buyer with streaming access to the digital file.

The system is further configured to provide a buyer with ability to publicly display the digital file.

The system is further configured to process payment from a buyer.

The system of is further configured to: collect a fee and/or payment on the transaction with the subsequent buyer; and provide the first user with a share of the fee and/or payment.

A method for tracking and controlling ownership of digital information comprises the steps of: receiving an first user's identification information; receiving an digital file from the first user; receiving identification information for a first buyer; generating a transfer key associated with both the digital file and the first buyer; transferring ownership of the digital file from the first user to the first buyer, wherein the transfer key is used to verify that the buyer is authorized to receive ownership of the artwork.

The method further comprises the steps of: receiving identification information for a subsequent buyer; generating a subsequent transfer key associated with both the digital file and the subsequent buyer; transferring ownership of the digital file from the first buyer to the subsequent buyer, wherein the subsequent transfer key is used to verify that the subsequent buyer is authorized to receive ownership of the artwork.

The method further comprises the step of generating a public key associated with the digital file, wherein the public key allows general access to information about the digital file.

The method of further comprises the step of providing viewers of the digital file with the public key corresponding to the digital file.

The method wherein the public key is provided in a QR code superimposed on the digital file when the digital file is displayed.

The method wherein the public key is provided in a hyperlink superimposed on the digital file when the digital file is displayed

The method further comprises the step of providing a buyer with streaming access to the digital file.

The method further comprises the step of providing a buyer with ability to publicly display the digital file.

The method further comprises the step of processing payment from a buyer.

The method further comprises the steps of: collecting a fee and/or payment on the transaction with the subsequent buyer; and providing the first user with a share of the fees and/or payments.

### BRIEF DESCRIPTION OF THE DRAWINGS

FIG. 1 illustrates a schematic overview of a computing device, in accordance with an embodiment of the present invention;

FIG. 2A illustrates a schematic of a system for providing a software controller, in accordance with an embodiment of the present invention;

FIG. 2B illustrates a schematic of a system for providing a software controller, in accordance with an embodiment of the present invention;

FIG. 2C illustrates a schematic of a system for providing a software controller, in accordance with an embodiment of the present invention;

FIG. 3 illustrates a network schematic of a system, in accordance with an embodiment of the present invention;

FIG. 4 is a process flow for an exemplary method in accordance with an embodiment of the present invention; and

FIG. 5 is a process flow for an exemplary method in accordance with an embodiment of the present invention.

### DETAILED SPECIFICATION

The present invention generally relates to systems and methods for tracking digital works and compensating authors thereof. Specifically, this invention relates to systems and methods for tracking and controlling ownership of digital works (e.g., images, video, sound, code, written works) and the compensation of the authors/artists and/or their representatives of such digital works throughout the lifespan of the digital work. Preferred embodiments of the present invention utilize security code keys to manage and track the digital works while a centralized or distributed computerized system manages compensation of the author/artist based on current value or transaction value of the related digital work.

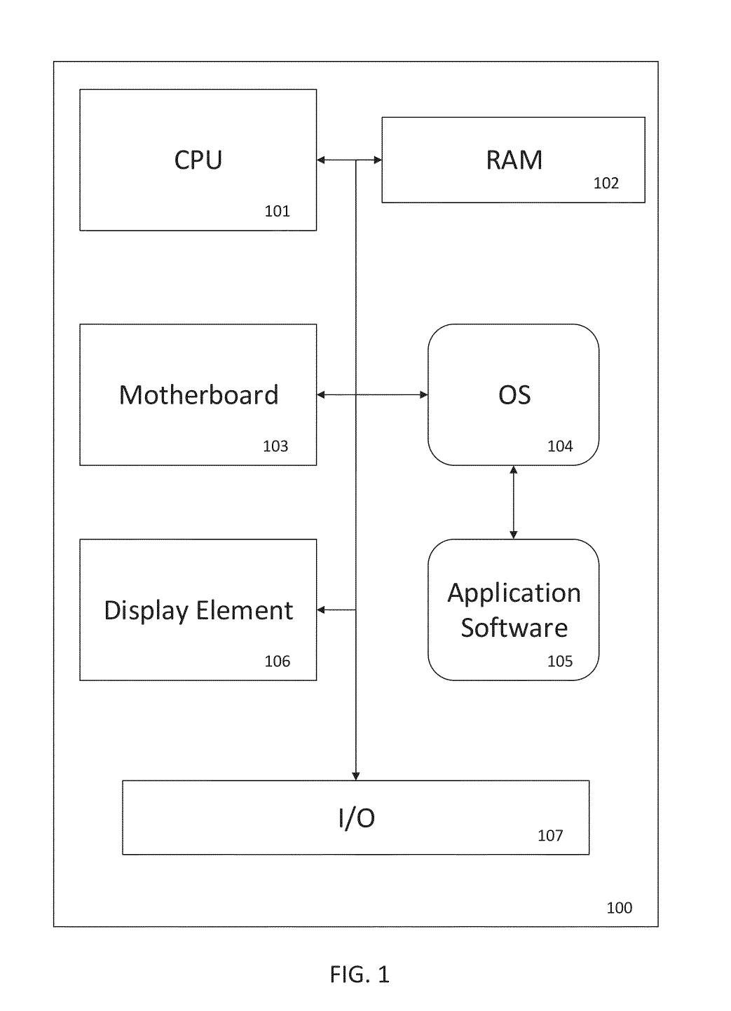

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more display element 106 and one or more input/output devices/means 107. Examples of computing devices usable with embodiments of the present invention include, but are not limited to, personal computers, smart phones, laptops, mobile computing devices and phablet/tablet PCs and servers. One of ordinary skill in the art would understand that any number of computing devices could be used, and embodiments of the present invention are contemplated for use with any computing device.

In a preferred embodiment of the present invention, the computing devices utilized will incorporate one or more input means and output means for use and interaction with the system. Input means may include, but are not limited to, touchscreen interfaces, keyboard interfaces, accelerometers, gyroscope, motion sensors, analog sticks, buttons, cameras, microphones and 3D imaging devices, or any combination thereof. Output means may include, but are not limited to, video displays elements, audio output devices (e.g., speakers, headphones), haptic output means (e.g., force feedback devices) or any combination thereof. One of ordinary skill in the art would appreciate that there are numerous input means and output means that could be utilized with embodiments of the present invention, and embodiments of the present invention are contemplated for use with any such input means and output means.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

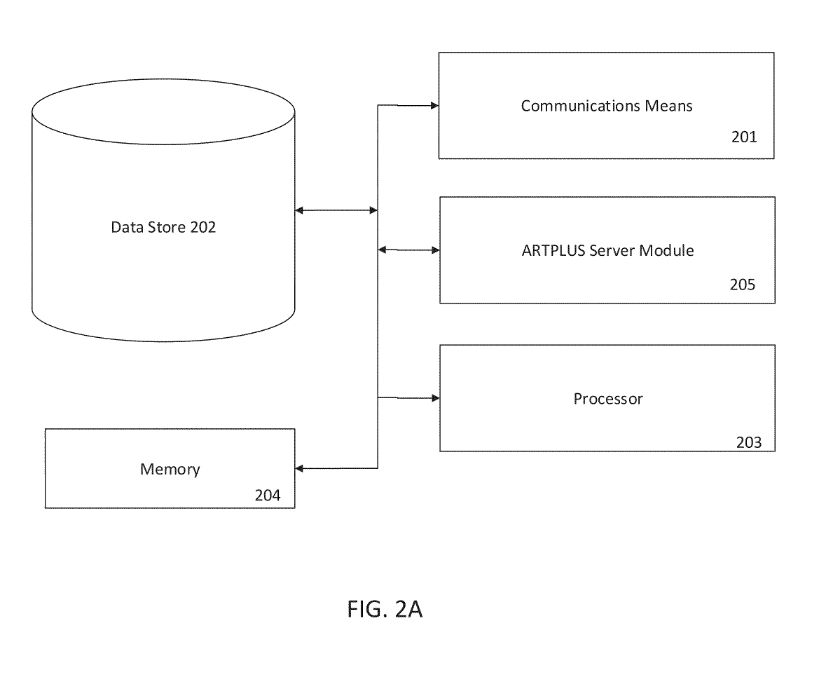

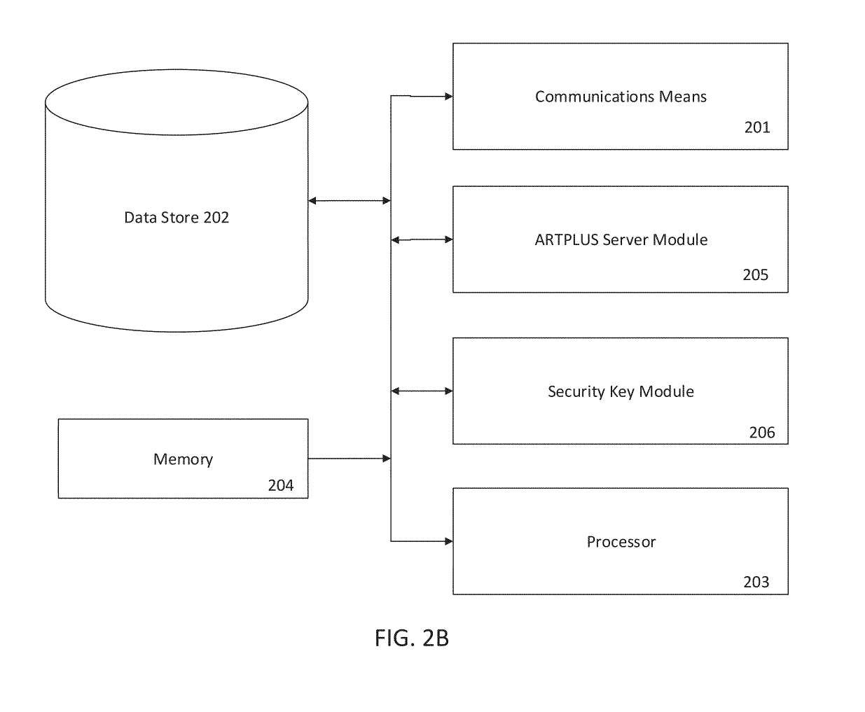

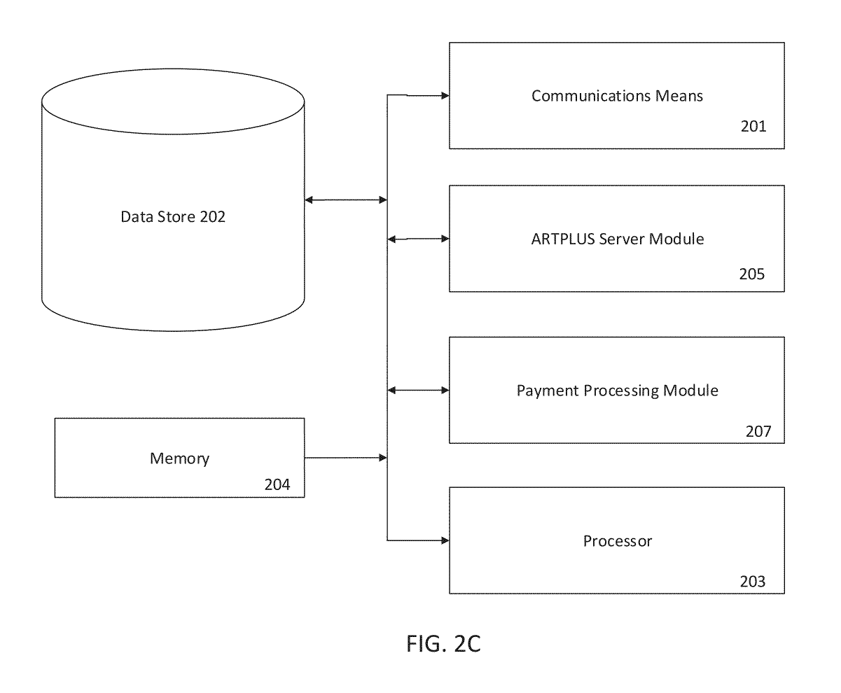

Turning to FIG. 2A, according to an embodiment of the present invention, a system for providing a digital artwork management system comprises one or more communications means 201, one or more data stores 202, a processor 203, memory 204, and an ARTPLUS Server Module 205. In FIG. 2B, according to an embodiment of the present invention, a system for providing a digital artwork management system comprises one or more communications means 201, one or more data stores 202, a processor 203, memory 204, an ARTPLUS Server Module 205, and a Security Key Module 206. In FIG. 2C, according to an embodiment of the present invention, a system for providing a digital artwork management system comprises one or more communications means 201, one or more data stores 202, a processor 203, memory 204, an ARTPLUS Server Module 205, and a Payment Processing Module 207. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means 201 of the system may be, for instance, any means for communicating data, voice or video communications over one or more networks or to one or more peripheral devices attached to the system. Appropriate communications means 201 may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means 201 that may be utilized with embodiments of the present invention, and embodiments of the present invention are contemplated for use with any communications means 201.

According to an embodiment of the present invention, an ARTPLUS Server Module 205 performs the functions required to enable the digital artwork control module, including, but not limited to receiving digital artwork from an artist, generating public keys, private keys, creator keys, and transfer keys, managing transfer of artwork, verifying user credentials and keys, collecting fees, and providing access to artwork for owners, creators, and their representatives.

According to an embodiment of the present invention, a Security Key Module 206 may be implemented in a separate module from the ARTPLUS Server Module. The Security Key Module handles the generation of security keys using encryption methods that are generally well known. The Security key module may also handle encryption and decryption using the security keys, verifying the identity of users through the security keys and generating new security keys when artwork is uploaded, or transferred.

According to an embodiment of the present invention, a Payment Processing Module 207 may handle the processing of fees or payments between clients and artists in place of the ARTPLUS Server Module. Fees may include administrative fees or transfer fees, subscription fees, or any other fees related to managing ownership of digital art. Payments may include the payments made from clients to artists in the sale of art or between clients in the transfer of art. The Payment Processing Module can handle payments directly or interface with a third-party payment system, such as PayPal, google wallet, credit card companies, escrow services, Square, Bitcoin, or any other method of transferring payments.

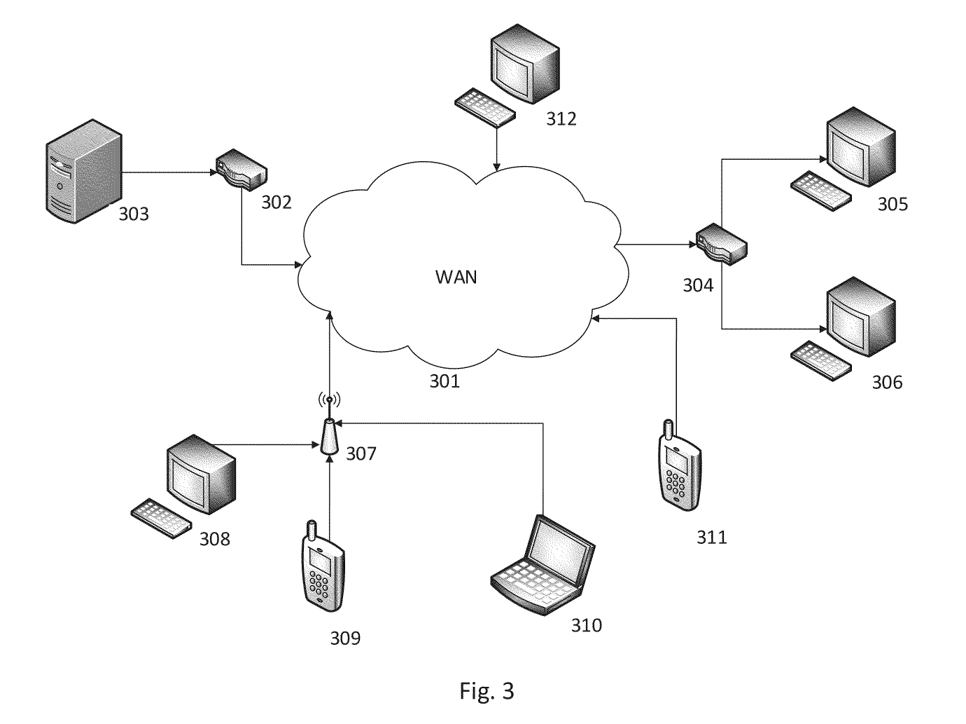

Referring to FIG. 3, a schematic overview of a system in accordance with an embodiment of the present invention is shown. The system is comprised of one or more application servers 303 for electronically storing information used by the system. Applications in the server 303 may retrieve and manipulate information in storage devices and exchange information through a WAN 301 (e.g., the Internet). Applications in server 303 may also be used to manipulate information stored remotely and process and analyse data stored remotely across a WAN 301 (e.g., the Internet).

According to an exemplary embodiment, as shown in FIG. 3, exchange of information through the WAN 301 or other network may occur through one or more high speed connections. In some cases, high speed connections may be over-the-air (OTA), passed through networked systems, directly connected to one or more WANs 301 or directed through one or more routers 302. Router(s) 302 are completely optional and other embodiments in accordance with the present invention may or may not utilize one or more routers 302. One of ordinary skill in the art would appreciate that there are numerous ways server 303 may connect to WAN 301 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 303 via WAN 301 or other network in numerous ways. For instance, a component may connect to the system i) through a computing device 312 directly connected to the WAN 301, ii) through a computing device 305, 306 connected to the WAN 301 through a routing device 304, iii) through a computing device 308, 309, 310 connected to a wireless access point 307 or iv) through a computing device 311 via a wireless connection (e.g., CDMA, GSM, 3G, 4G) to the WAN 301. One of ordinary skill in the art would appreciate that there are numerous ways that a component may connect to server 303 via WAN 301 or other network, and embodiments of the present invention are contemplated for use with any method for connecting to server 303 via WAN 301 or other network. Furthermore, server 303 could be comprised of a personal computing device, such as a smartphone, acting as a host for other computing devices to connect to. While many components of the system are web-based or otherwise utilize computing devices over networks, such as the internet, certain aspects of the invention may be provided by analog systems (e.g., landline telephones could be utilized to call and leave voicemails which may be digitized and converted into useable components within the system).

According to an embodiment of the present invention, the system is configured to secure ownership of digital works by acting as an arbiter between artists/authors and/or their representatives (collectively referred to herein as authors) of digital works. Digital works include, but are not limited to, images, videos, sound recordings, software code, books, e-books, or any combination thereof. One of ordinary skill in the art would appreciate that there are numerous types of digital works that could be utilized with embodiments of the present invention and embodiments of the present invention are contemplated for use with any type of digital work. For the purpose of the system and methods described herein, digital works need not only be individual works, but may also include multiplied versions of a work in open or numbered editions (e.g., limited editions/runs).

According to an embodiment of the present invention, the system may be configured to provide a centralized or distributed repository for storing, verifying and providing security and ownership information associated with one or more digital works and the authors and owners thereof. In a preferred embodiment of the present invention, the system may be configured to utilize one or more security code keys to identify each of the parties associated with a digital work (e.g., author and/or their representative(s), current owner, former owner). Through use of specific security code keys, the system can identify specific rights belonging to a specific party.

According to an embodiment of the present invention, security code keys utilized by the system may include one or more of a Private Key, Public Key, Creator Key, Trade Key, Transfer Key, Representative Key, Ownership Key or any combination thereof. In certain embodiments of the present invention, there may be multiple keys for one or more specific key types (e.g., multiple Ownership Keys where there is more than one owner or where the system is configured to store information related to previous owners and generate New Ownership Keys for each new owner).

The various keys may be generated via one or more key generation means, such as one or more public-key cryptographic methodologies including, but not limited to, Diffie-Hellman key exchange protocol, Digital Signature Standard (DSS), elliptic curve techniques, password-authenticated key agreement techniques, RSA encryption algorithms, Cramer-Shoup cryptosystems, YAK authenticated key agreement protocol, or any combination thereof. One of ordinary skill in the art would appreciate that there are numerous types of cryptographic methods that could be utilized with embodiments of the present invention, and embodiments of the present invention are contemplated for use with any cryptographic method.

In preferred embodiments, the cryptographic method selected should allow for the generation of multiple keys, preferably referring to a single key (i.e., Private Key). In alternate embodiments, the system may be configured to store and relate multiple Private Keys with a Creator Key/creator Private Key in order to maintain the hierarchy of ownership and creatorship associated with a digital work. In certain embodiments, particularly where multiple copies of the digital work are available (e.g., open/limited numbered editions), the system may either create a single Creator Key for the entire series or an individual Creator Key for each copy. In the case of multiple copy digital works, each copy may be particularly identified via the key pairing or via data included with the digital work (e.g., metadata on the digital work, numbering in the digital work).

According to an embodiment of the present invention, upon interaction with the system by an author, the system will generate a Creator Key to associate with a newly uploaded or to-be uploaded digital work. The Creator Key is associated with the digital work and the author and/or their representatives and is stored by the system so that the digital work is always associated with the author, no matter who the later owner(s) of the digital work are. The system may provide various ways to access the Creator Key, such as via a login (e.g., user name/password combination), email, or by some kind of limited sharing to allow the artist to provide the creator key to anyone assigned to upload artwork or manage the digital inventory of artworks. User identification and authorization can be done in any of a variety of ways, including, but not limited to, username password combination, personalized questions, access codes, phone number verification, fingerprinting, iris scan, or any kind of biometric identification method. Once the system has identified an author, the author may take various actions with respect to the digital work, such as providing various formats (e.g., different file formats, different resolution types, different bitrates, different quality, compressed formats), checking status and ownership of a digital work, authorizing a transfer of the digital work, checking or confirming fees associated with transfers of the digital work, or any combination thereof. In certain embodiments, an author may be able to login to the system once and be able to manage all of their digital works via a single user interface or a single integrated platform, allowing authors to manage a body of work with a single account. One of ordinary skill in the art would appreciate that there are numerous actions an author could take once logged into the system, and embodiments of the present invention are contemplated for use with any appropriate action.

According to an embodiment of the present invention, the system may be configured to also allow an author to assign a representative to the digital work, such as an agent, artist representative or other affiliate who has the permission of the author to take one or more actions with respect to the digital work. Upon assignment of a representative, the system may be configured to generate and/or associate with the representative one or more representative keys. The system provides authors with the ability to define the set of privileges and/or actions that a representative can take with respect to the digital work. In certain embodiments, the system may allow an author to select from a list of default privilege settings.

With respect to digital works and linking the works with an author and the system in general, the system may be configured to modify or otherwise augment the digital work in order to provide identification information and associate the modified digital work with the author as well as one or more owners. Augmentation or modification of the digital work may be done by way of appending data to the digital work file (e.g., after end of file, before file start), adding metadata to the digital work or to file(s) associated with the digital work, adding markers in the digital work file, adding graphical, textual or other identifiers in the digital work (e.g., watermark, QR code, hyperlink, serial number, identification number), or any combination thereof. One of ordinary skill in the art would appreciate that there are numerous methods for augmenting or modifying a digital work to include identification information, and embodiments of the present invention are contemplated for use with any appropriate method.

Once a digital work is appropriately augmented and added to the system by its author, the system can provide numerous methods related to the ownership and management of the digital work. A first action that may be taken is the transfer of a digital work from the author (or current owner if previously transferred from an author to a new owner). In this case, the system may be configured to generate a Transfer Key for the current owner to provide to the proposed new owner. Once the current owner has agreed to transfer the digital work to a new owner (e.g., upon completion of a transaction for payment of the digital work), the current owner may provide the Transfer Key to the new owner, such as via email or any other electronic or physical medium. The new owner can then use the Transfer Key to interact with the system in order to effect the transfer to the new owner. Upon interaction with the system, the new owner can verify and confirm the transfer as well as update any ownership information related to the transfer and the new owner.

In certain embodiments, the system may be configured to automatically send the Transfer Key to the new owner on behalf of the current owner. For instance, the current owner may confirm a transfer transaction, including the email address of the new owner, and the system will automatically generate and transmit the Transfer Key to the new owner. After receipt, the new owner may take actions with respect to the digital work.

In certain embodiments, the system may be configured to act as a payment system or clearinghouse for the transfer of digital works. In a preferred embodiment, the system may be configured to require payment for the transfer of a digital work from a current owner/author to a new owner. Each transfer request may be subject to prior transaction fee payment before a transfer is affected. In other embodiments, payment transactions may be processed or otherwise handled by a third-party payment provider (e.g., PayPal, merchant service systems, escrow systems, banks, financial institutions). One of ordinary skill in the art would appreciate that there are numerous types of third-party payment providers that could be utilized with embodiments of the present invention and embodiments of the present invention are contemplated for use with any third-party payment provider.

In other embodiments, the system may act as a clearinghouse for the digital works, providing complete transactional control over the transfer of ownership of a digital work. In other words, the system may not only request a transfer fee, but also handle the processing of a purchase fee between a current owner/author and a new owner. In this manner, the system will not affect the transfer of ownership of the digital work until such time as the payment for the digital work is completed. Once complete, the transfer may be affected.

According to an embodiment of the present invention, the system may be configured to generate a new set of keys after each transfer, allowing for security to be maintained. In certain embodiments, the previous keys may be stored by the system for use in tracking the history of transfers and ownership of various digital works. For instance, a former owner of a digital work (or an author) could use their previously provided key to interact with the system and find out current status of a digital work (e.g., current owner, transfer history). In other embodiments, access such as this could be limited, or limited at the request of the current owner, due to privacy or other concerns.

According to an embodiment of the present invention, the system may be configured to provide the current owner with an Ownership Key, which allows the user to take actions on the digital work. The Ownership Key may allow the current owner to update ownership information, propose transfers and view other information related to the digital work.

According to an embodiment of the present invention, the system may be configured to allow the author, who is in possession of a Creator Key, the ability to track the history and current information of the digital work. This will allow the author to track the digital work in the secondary market. This may be especially important in legal jurisdictions that allow authors to have moral rights in their works. If the author feels their work is being used in a manner that violates their moral or other legal rights, the author can track down and enforce these rights against the current, or former, owners. Further, in certain embodiments, the system may allow the author to enforce these moral or other legal rights by way of locking the keys or access to the digital work by any current or former owner who the author believes is violating these rights. In these embodiments, the system may also be able to initiate a “kill switch”, whereby any digital work the system has access to associated with such locked key can be disabled such as by encrypting the digital work so that the current owner or previous owner could no longer access the digital work until the author lifts the lock.

According to an embodiment of the present invention, it is another aspect of the system to provide the ability for authors to profit or be compensated for increases in value of their work over time. For instance, the system may be configured to compensate the author for increases in value of the work when transferred from a current owner to a new owner. In an example, if an author sold a digital work to a first owner for $100, and the first owner later sells the work to a second owner for $200, the system may be configured to transfer a portion of the windfall to the author. The amount of the windfall may vary and one of ordinary skill in the art would appreciate there are numerous ways to calculate compensation for the windfall (e.g., percentage of net revenue, fixed fee, scaled fee based on increase or an additional buyers premium due upon purchase of the work). Similarly, the system may be configured to provide profit sharing or other compensation to a representative associated with the work and/or author. In this manner, a representative may be rewarded automatically as agreed upon between the author and the representative.

### Exemplary Embodiment

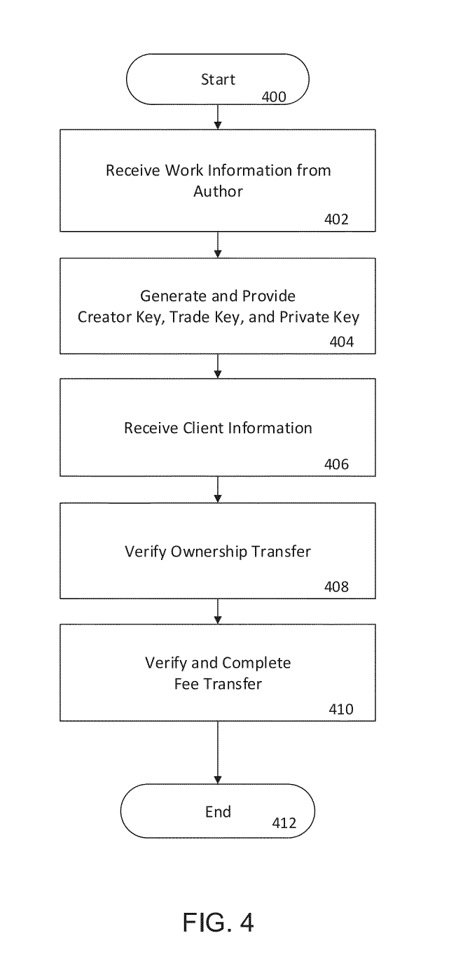

The following is an exemplary embodiment of a method for utilization of the system and method as described herein, as shown in FIG. 4. At step 400, the process starts with a user engaging the system in order to perform some transaction related to a digital work. The user, in this case an author, submits information related to a digital work.

At step 402, the system receives the information related to the digital work from the author. The information will include at least the identity of the author or an identifier associated with the author and information related to the digital work. In preferred embodiments, the author will also provide a copy of the digital work to the system for augmentation of the digital work to incorporate identification information.

At step 404, the system generates a Private Key, Trade Key and a Creator Key. A Private Key is assigned to all ARTPLUS members and is used to manage the personal data of ARTPLUS members or their representatives and is intended to be kept private to the ARTPLUS member. The Creator Key is assigned ARTPLUS members who upload a digital work as a creator. The Creator Key is used by the art creator, the creator's representatives, or the collectors to manage the collection of art without having to have access to the Private Key which should not be shared. The Trade Key is associated with the owner and is primarily used to initiate a transfer or sale of a digital work. The system also associates the Creator Key with the author and provides the Creator Key to the author. The system may further be configured to store the Trade Key and/or Creator Key for later use, store a copy of the digital work (augmented, non-augmented or both), store author information and associate author information with the Creator Key, Trade Key, and/or digital work. At this point, the author can take any action with respect to the digital work as the digital work is now secured and identified by the system.

For the purpose of this exemplary method, the user is choosing to transfer the ownership of the digital work to a new owner by entering the Trade Key and has a Transfer Key generated and sent to a new owner (i.e., client).

At step 406, the system receives a request from the client with respect to the transfer of ownership of the digital work to the client. The request includes client information and a copy of the Transfer Key required to access and transfer the digital work form the author to the client.

At step 408, the system has all the information it needs to analyse the transaction. The system uses the previously received information from the client to verify the Transfer Key and that the transfer is a valid transfer as authorized by the author.

Step 410 is optional and applicable if there is a payment transaction to be completed in association with the transfer of the digital work (in certain embodiments, payment may occur outside of the system). If there is payment to be conducted, the payment would be handled and processed at this step by the system. Once verified, and payment made where applicable, the system will complete the transfer and the process will terminate at step 412.

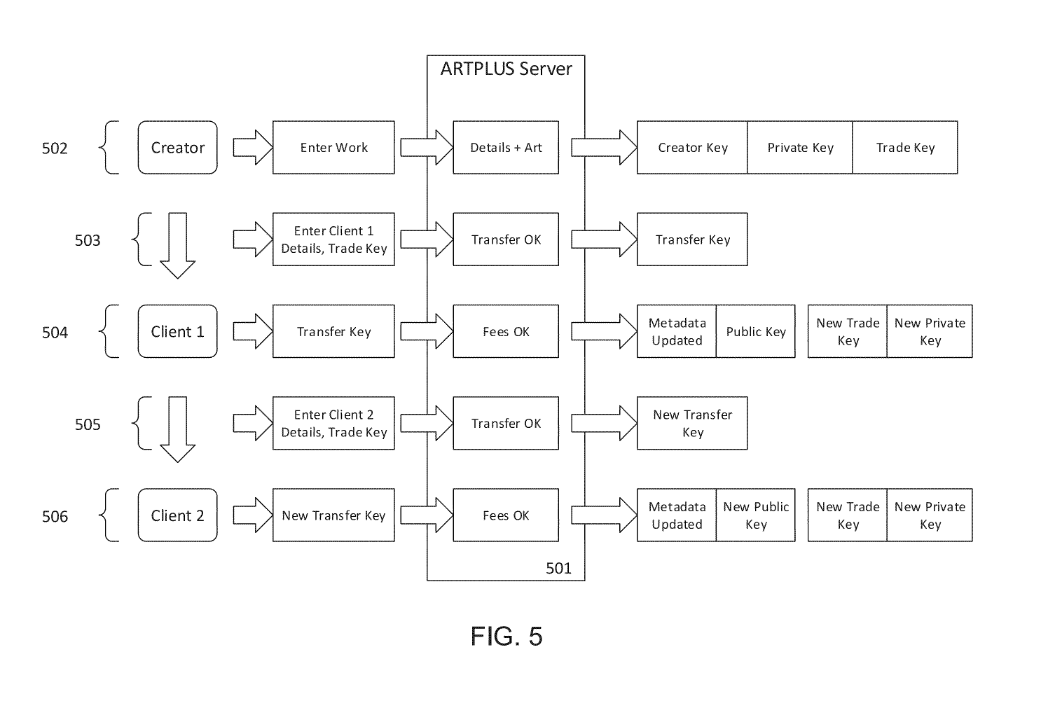

Turning now to FIG. 5, an exemplary process of the transfer of ownership and rights with respect to a digital work over a lifetime is shown. As shown in this process, the creator (author) will submit their work to the ARTPLUS Server 501 (i.e., the system) in step 502. The submission will contain the art (digital work) and details (information associated with the digital work). The ARTPLUS Server 501 generates for all member types a Private Key, and a Trade Key. In addition, for artists, the system also generates a Creator Key. The Private Key is used to manage the personal data of ARTPLUS members or their representatives and is intended to be kept private to the ARTPLUS member. The Creator Key is used by the art creator, the creator's representatives or the collectors and the Trade Key is used to initiate sales transactions of artworks. The Creator Key and Trade Key are intended to have limited sharing in order to enable multiple people to manage artwork and transactions in an organization.

The process with respect to transfer of ownership of the digital work, as shown in FIG. 5, is the same for Client 1 and Client 2. The creator, in step 503, enters the Trade Key and the details for Client 1 that is buying the work of art. Client 1 can be identified by email address, user ID, or any other identifier of Client 1. One of ordinary skill in the art would recognize that there are a variety of ways to identify Client 1 who is buying the work of art. The ARTPLUS Server 501 also generates a Transfer Key for the client in step 503. The Transfer Key is tied to the particular work of art and the client to which the artwork is being sold and/or the creator or artist of the artwork. The Transfer Key cannot be used by anyone other than the Client identified by the seller of the artwork.

In step 504, Client 1 will send the Transfer Key to the ARTPLUS Server 501, and the ARTPLUS server verifies that fees have been paid. The fees may include administrative fees, fair trade fees, or commissions, and in some embodiments of the invention, may also include handling the actual purchase transaction between the buyer and seller. The ARTPLUS Server then generates a Public Key and updates the metadata of the art work. The Public Key is tied to the particular work of art and can be used to provide access to the artwork to third parties without transferring ownership. The Public Key may also be used by viewers of the artwork to access information about the artwork, the artist, or any other information associated with the artwork and/or to request a purchase of a copy of the artwork identified by the Public Key. In step 504, if Client 1 is a new user of the system, a new Private Key and a new Trade Key associated with Client 1 will also be generated by the ARTPLUS Server 501. The new Trade Key will be used by Client 1 to initiate a subsequent sale of the digital work to a Client 2.

When Client 1 decides to sell the art work to Client 2, as illustrated beginning at 505, he provides the new Trade Key and Client 2's details to the ARTPLUS Server 501, which generates a new Transfer Key and sends the new Transfer Key to Client 2. Client 2 then provides the new Transfer Key to the ARTPLUS Server 501 in step 506. The ARTPLUS Server 501 verifies that fees are paid, updates the metadata for the artwork, and generates a new Public Key for client 2. Once again, if Client 2 is a new user to the system, the ARTPLUS Server generates a new Private Key and a new Trade Key associated with Client 2. This process repeats for subsequent sales in the secondary market. Each time an artwork is transferred, the system generates a new Public Key and updates the metadata of the artwork for each subsequent new owner of the artwork.

The system described herein provides a way for Artists to manage sale, licensing, and use of their artworks. It also provides a way for the artists to see which buyers of their works are generating the most exposure by tracking which Public Keys are used to access information about the artwork. Although management and sales of digital artwork is used to illustrate the present invention, it is contemplated that the system and method could be used for managing ownership and transfer, with or without an exchange of money, of any kind of digital information, including, but not limited to, program files, documents, security keys, ebooks, music, computer code, text, or any kind of digital information.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well as one or more databases configured for storage and retrieval of moving information and estimate information. In other embodiments, data may be stored and retrieved from system utilizing unformatted or non-relational data, such as structured storage means (e.g., NoSQL).

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for tracking and controlling ownership of digital information comprising:
a processor, and memory with computer executable code configured to:
receive a first user's identification information;
receive a digital file from said first user;
receive identification information for a first buyer;
generate a first transfer key associated with both said digital file and said first buyer; and
transfer ownership of said digital file from said first user to said first buyer, wherein said first transfer key is used to verify that said first buyer is authorized to receive ownership of said digital file.

2. The system of claim 1 further configured to:
receive identification information for a subsequent buyer;
generate a subsequent transfer key associated with both said digital file and said subsequent buyer; and
transfer ownership of said digital file to said subsequent buyer, wherein said subsequent transfer key is used to verify that said subsequent buyer is authorized to receive ownership of said digital file.

3. The system of claim 1 further configured to generate a public key associated with said digital file, wherein said public key allows general access to information about said digital file.

4. The system of claim 3 further configured to provide viewers of said digital file with the public key corresponding to said digital file.

5. The system of claim 4 wherein said public key is provided in a QR code superimposed on said digital file when said digital file is displayed.

6. The system of claim 4 wherein said public key is provided in a hyperlink superimposed on said digital file when said digital file is displayed.

7. The system of claim 1 further configured to provide a buyer with streaming access to said digital file.

8. The system of claim 1 further configured to provide a buyer with ability to publicly display said digital file.

9. The system of claim 1 further configured to process payment from a buyer.

10. The system of claim 2 further configured to:
collect a fee and/or payment on the transaction with said subsequent buyer; and
provide said first user with a share of said fee and/or payment.

11. A method for tracking and controlling ownership of digital information comprising the steps of:
receiving an first user's identification information;
receiving an digital file from said first user;
receiving identification information for a first buyer;
generating a transfer key associated with both said digital file and said first buyer; and
transferring ownership of said digital file from said first user to said first buyer, wherein said transfer key is used to verify that said buyer is authorized to receive ownership of said artwork.

12. The method of claim 11 further comprising the steps of:
receiving identification information for a subsequent buyer;
generating a subsequent transfer key associated with both said digital file and said subsequent buyer; and
transferring ownership of said digital file from said first buyer to said subsequent buyer, wherein said subsequent transfer key is used to verify that said subsequent buyer is authorized to receive ownership of said artwork.

13. The method of claim 11 further comprising the step of generating a public key associated with said digital file, wherein said public key allows general access to information about said digital file.

14. The method of claim 13 further comprising the step of providing viewers of said digital file with the public key corresponding to said digital file.

15. The method of claim 14 wherein said public key is provided in a QR code superimposed on said digital file when said digital file is displayed.

16. The method of claim 14 wherein said public key is provided in a hyperlink superimposed on said digital file when said digital file is displayed

17. The method of claim 11 further comprising the step of providing a buyer with streaming access to said digital file.

18. The method of claim 11 further comprising the step of providing a buyer with ability to publicly display said digital file.

19. The method of claim 11 further comprising the step of processing payment from a buyer.

20. The method of claim 12 further comprising the steps of:
collecting a fee and/or payment on the transaction with said subsequent buyer; and
providing said first user with a share of said fees and/or payments.
